(19) United States
(12) Patent Application Publication
(10) Pub. No.: US 2015/0059189 A1
(43) Pub. Date: Mar. 5, 2015

(54) Drywall Corner Flush-Cutting Guide

(71) Applicant: Paul Anthony Nicosia, New York, NY (US)

(72) Inventor: Paul Anthony Nicosia, New York, NY (US)

(21) Appl. No.: 14/010,663

(22) Filed: Aug. 27, 2013

(51) Int. Cl. B26B 25/00; B26B 29/06

(52) U.S. Cl. CPC B26B 25/007; B26B 29/06
USPC 30/282

(57) ABSTRACT

A device capable of scoring the exterior side of drywall at a point where two drywall surfaces meet to form a corner and one of the drywall surfaces runs past the other by a distance of approximately less than two inches. The device uses the intersecting surface as a guide and includes a flat guide plate which sits above a C-shaped structure that has a cutting wheel that exists on the same plane as the intersecting surface.

### FIELD OF THE INVENTION

The present invention relates to a novel drywall scoring device.

### BACKGROUND OF THE INVENTION

During typical drywall installation, when two drywall surfaces meet to form a corner, the person installing or “hanging” the drywall will intentionally hang each piece of drywall so that it runs past the other. This is done to permit the installer to score the backside of the drywall or “back-cut” it at the point where it runs past the other in order to “snap” the drywall off at the exact point of intersection to produce a “clean” corner.

However, in order to “snap” the drywall off at the exact point of intersection and produce a “clean” and “neat” corner that is ready for the next step in the finishing process, the drywall must run past the intersecting drywall by a distance of more than approximately two inches in order to have the leverage needed to “snap” off the drywall.

Many times an installer for several different reasons will run the drywall past the intersecting drywall surface at a distance of less than approximately two inches. This necessitates the very tedious process of removing the overhanging waste drywall. This process includes transferring the measurement from the backside point of intersection to the finish side at each end, snapping a chalk line and then cutting off the overhanging waste drywall by the use of a reciprocating saw, a drywall handsaw (or “meatsaw”) or by any other known means.

### SUMMARY OF THE INVENTION

The object of the present invention is to provide a device capable of scoring the exterior side of drywall at a point where two drywall surfaces meet to form a corner (and one of the drywall surfaces runs past the other by a distance of approximately less than two inches) by using the intersecting surface as a guide.

The present invention achieves that object and comprises a monolithic structure that consists of a flat guide plate above a C-shaped open-ended mid-section with an approximately two inch by approximately one inch cavity with a cutting wheel (or any other means of cutting) that cuts along the same plane as the flat surface of the guide plate.

### BRIEF DESCRIPTION OF THE DRAWINGS

The present invention can be more fully understood by reference to the following description and accompanying drawings in which:

FIG. 1 is a perspective view of one embodiment of the present invention.

FIG. 2 is a perspective sectional view of one embodiment of the present invention in position for its intended use.

FIG. 3 is a perspective elevation view of one embodiment of the present invention in position for its intended use.

FIG. 4 is a perspective view of a second embodiment of the present invention in which the cutting means is a fixed blade rather than a cutting wheel.

### DETAILED DESCRIPTION OF THE INVENTION

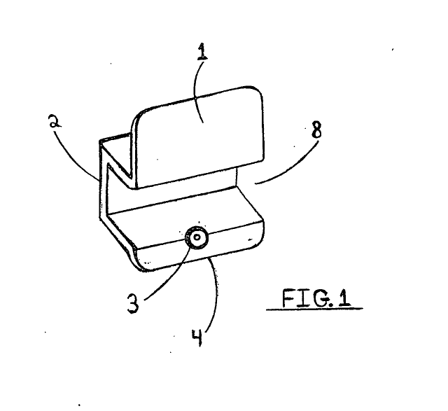

FIG. 1 is a perspective view of one embodiment of the present invention. The embodiment depicted in FIG. 1 comprises a monolithic structure (4) having a flat guide plate (1) above a C-shaped open-ended mid-section (2) with an approximately one inch by approximately two inch cavity (8) with a cutting wheel (3) that cuts along the same plane as the flat surface of the guide plate (1).

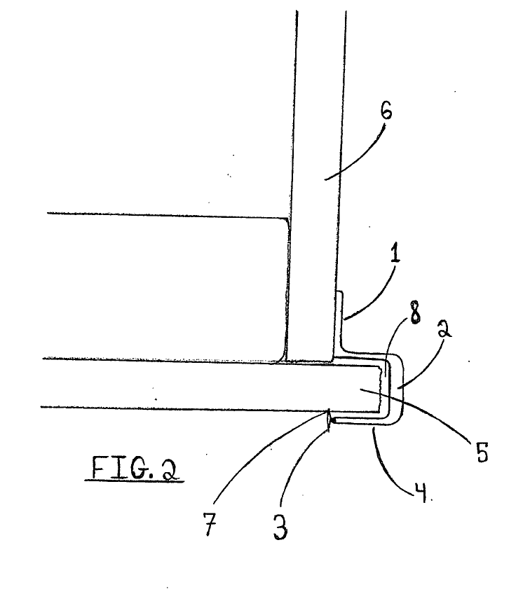

FIG. 2 is a perspective sectional view of one embodiment of the present invention in position for its intended use. The embodiment depicted in FIG. 2 is used by pressing the guide plate (1) on an adjacent surface (6) while scoring the finish side (7) of the intended surface while allowing the overhanging waste drywall (5) to pass through the open-ended cavity (8).

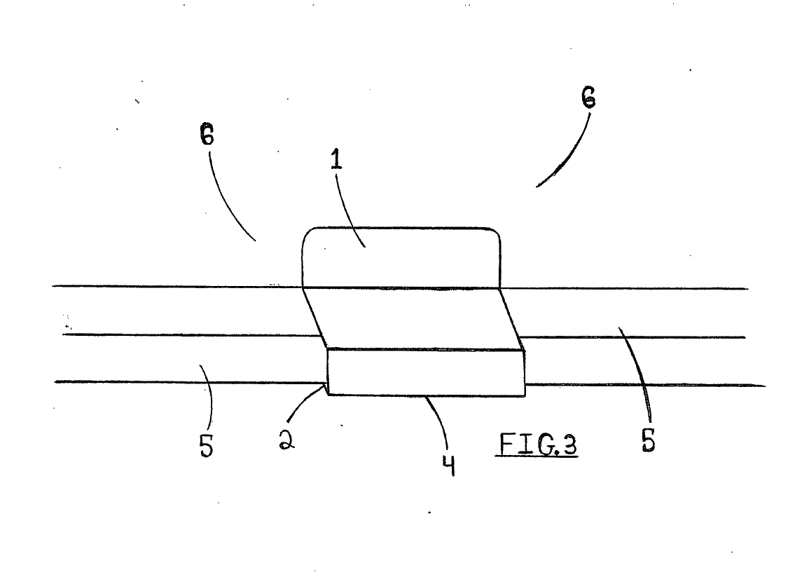

FIG. 3 is a perspective elevation view of one embodiment of the present invention in position for its intended use. FIG. 3 depicts a monolithic structure (4) where the guide plate (1) is pressing on an adjacent surface (6) while the overhanging waste drywall (5) passes through the C-shaped open-ended mid-section (2).

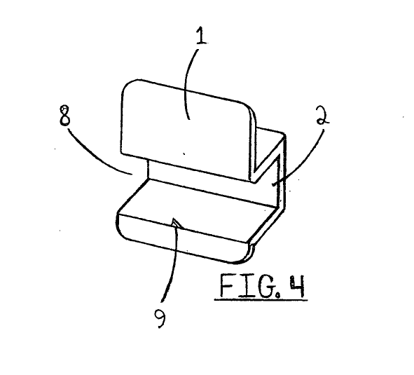

FIG. 4 is a perspective view of a second embodiment of the present invention. The embodiment depicted in FIG. 4 comprises a flat guide plate (1) above a C-shaped open-ended mid-section (2) with an approximately one inch by approximately two inch cavity (8) where the cutting means is a fixed blade (9) rather than a cutting wheel.

As used herein, the term “drywall” means sheetrock, denseglass, coreboard, backerboard, or any other construction surface materials known and unknown.

In addition, different embodiments of the present invention may be manufactured using a variety of media. Embodiments of the present invention may also be manufactured in a variety of sizes without departing from the spirit of the invention defined by the appended claims.

While the invention has been described with reference to certain embodiments thereof, it is to be understood that modifications or variations may be easily made without departing from the spirit of this invention defined by the appended claims.

What is claimed is:

1. A drywall corner flush-cutting guide comprising:
a) a flat guide plate located above a roughly C-shaped open-ended mid-section with an approximately one inch by approximately two inch cavity; and
b) a cutting element positioned so that it cuts along the same plane as the flat surface of the flat guide plate.

2. The drywall corner flush-cutting guide of claim 1, wherein the cutting element is a cutting wheel.

3. The drywall corner flush-cutting guide of claim 1, wherein the cutting element is a fixed blade.
